(19) United States
(12) Patent Application Publication
(10) Pub. No.: US 2026/0112993 A1
(43) Pub. Date: Apr. 23, 2026

(54) SOLAR MODULE PLACEMENT

(71) Applicant: Botcrew Technologies Corporation, Duluth, MN (US)

(72) Inventor: Andrew J. Archer, Duluth, MN (US)

(21) Appl. No.: 19/360,560

(22) Filed: Oct. 16, 2025

Related U.S. Application Data
(60) Provisional application No. 63/708,675, filed on Oct. 17, 2024.

(51) Int. Cl. H02S 20/30; H02S 99/00

(52) U.S. Cl. CPC H02S 20/30; H02S 99/00

(57) ABSTRACT

The present disclosure provides a method for solar module placement. The method includes gripping, via a first arm of the robotic vehicle, a front face of a solar module. The method includes placing, via the first arm, the solar module above a torque bar such that a back face of the solar module is positioned proximate to a bracket of the torque bar. The method includes obtaining, via a sensor disposed in a second arm of the robotic vehicle as the second arm is located beneath the bracket, image data of the bracket. The method includes translating the image data into a pose for the first arm gripping the solar module. The method includes adjusting at least one of a position or an orientation of the first arm based on the pose. The method includes securing, via the second arm, the solar module to the bracket by a fastener.

### CROSS REFERENCE TO RELATED APPLICATIONS

This application claims priority to U.S. Provisional Patent Application No. 63/708,675, filed on October 17, 2024 and entitled “SOLAR MODULE PLACEMENT”, the entire contents of which are incorporated herein by reference.

### TECHNICAL FIELD

Aspects of the present disclosure relate to solar technology, and more particularly, to solar panel placement.

### BACKGROUND

Renewable energy sources are becoming increasingly important to power devices. One type of renewable energy is solar energy. To harvest solar energy, a solar module (which may also be referred to as a solar panel) converts sunlight into electricity using photovoltaic (PV) cells. Photovoltaic cells are made of materials that generate excited electrons when exposed to light. The electrons flow through a circuit and produce direct current (DC) electricity which can be utilized to power various devices or which can be stored in batteries.

Solar modules may be connected together in arrays that cover a geographic area (e.g., ten acres, one-hundred acres, etc.) in order to harvest relatively large amounts of solar energy. Such an arrangement may be referred to as a solar park or a solar farm. In a solar park, solar modules may be connected to torque bars (which may also be referred to as a torque tubes) that are supported by posts embedded into the ground. A torque bar may be located four to five feet from the ground. A torque bar is a structural component that supports solar modules, keeps the solar modules aligned, and that helps to capture sunlight (e.g., by rotating the solar modules to be directed towards the sun). A torque bar also provides a platform for routing cables. A solar park may include many rows of torque bars, and each torque bar may be connected to many solar modules (e.g., hundreds of solar modules). As such, some solar parks may include thousands of solar modules.

### SUMMARY

According to one aspect, the disclosure is generally directed to a method of installing solar modules performed by a robotic vehicle, the method comprising gripping, via a first arm of the robotic vehicle, a front face of a solar module, placing, via the first arm of the robotic vehicle, the solar module above a torque bar such that a back face of the solar module is positioned proximate to a bracket of the torque bar, obtaining, via a sensor disposed in a second arm of the robotic vehicle as the second arm is located beneath the bracket of the torque bar, image data of the bracket, translating the image data of the bracket into a pose for the first arm gripping the solar module, adjusting at least one of a position or an orientation of the first arm based on the pose, and securing, via the second arm as the second arm is located beneath the bracket, the solar module to the bracket by a fastener.

In some example aspects, the solar module rests on a surface on a side face of the solar module prior to the gripping, and wherein gripping the front face of the solar module comprises gripping the front face of the solar module as the solar module rests on the surface on the side face.

In some example aspects, the method further comprises navigating the robotic vehicle to a location of the torque bar based on at least one of a map of a solar site or a global navigation satellite system. In some further example aspects, the first arm and the second arm are in a non-extended position on the robotic vehicle prior to the robotic vehicle arriving at the location of the torque bar, the method further comprising extending the first arm and the second arm when the robotic vehicle arrives at the location. In some still further example aspects, a height of the robotic vehicle when the first arm and the second arm are in the non-extended position is less than five feet.

In some example aspects, translating the image data of the bracket into the pose for the first arm comprises identifying a centroid of at least one hole in the bracket based on the image data, wherein the pose is based on the centroid.

In some example aspects, gripping the front face of the solar module comprises gripping the front face via a suction cup disposed in the first arm.

In some example aspects, the front face of the solar module comprises solar cells, and wherein the back face of the solar module comprises an opening for the bracket.

In some example aspects, the fastener comprises a huck bolt.

In some example aspects, the first arm comprises a first plurality of segments and the second arm comprises a second plurality of segments, wherein the first plurality of segments includes a gripping segment, and wherein the second plurality of segments includes the sensor and a fastening tool.

In some example aspects, the method further comprises releasing a grip of the first arm of the robotic vehicle from the front face of the solar module subsequent to securing the solar module to the bracket.

In some example aspects, the sensor comprises a depth camera, and wherein the image data comprises a point cloud.

In some example aspects, the method further comprises moving the second arm of the robotic vehicle to a first position beneath the bracket of the torque bar prior to obtaining the image data, and moving the second arm of the robotic vehicle to a second position beneath the bracket subsequent to adjusting at least one of the position or the orientation of the first arm, wherein securing the solar module to the bracket by the fastener occurs when the second arm is in the second position.

In some example aspects, the method further comprises capturing an image of the solar module subsequent to the solar module being secured to the bracket.

According to another aspect, the disclosure is generally directed to a robotic vehicle, comprising a first arm, a second arm, a sensor disposed in the second arm, a computing system, comprising a processor, and memory storing instructions, that when executed by the processor, cause the processor to implement the method as described in any of the preceding aspects.

In some example aspects, the robotic vehicle further comprises a first actuator coupled to the first arm, a second actuator coupled to the second arm, wherein the instructions, when executed by the processor, cause the processor transmit signals to the first actuator and the second actuator in order to control at least one of a position or an orientation of at least one of the first arm or the second arm.

In some example aspects, the robotic vehicle further comprises a propulsion system.

According to another aspect, the disclosure is generally directed to a computing system, comprising a processor and memory storing instructions that, when executed by the processor, cause the processor to implement the method as in any of the preceding aspects.

According to another aspect, the disclosure is generally directed to a non-transitory computer readable storage medium comprising instructions that, when executed by the processing device, cause the processing device to implement a method as in any of the preceding aspects.

According to another aspect, the disclosure is generally directed to a robotic vehicle comprising means for performing the method as described in any of the preceding aspects.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example of a robotic vehicle for solar module placement in accordance with some aspects of the present disclosure.

FIG. 2A is a diagram that illustrates an example view of a solar module in accordance with some aspects of the present disclosure.

FIG. 2B is a diagram that illustrates an example view of a solar module in accordance with some aspects of the present disclosure.

FIG. 2C is a diagram that illustrates an example view of a solar module in accordance with some aspects of the present disclosure.

FIG. 2D is a diagram that illustrates an example view of a solar module in accordance with some aspects of the present disclosure.

FIG. 3 is a diagram that illustrates an example of an under-construction solar farm in accordance with some aspects of the present disclosure.

FIG. 4A is a diagram that illustrates an example of solar module placement in accordance with some aspects of the present disclosure.

FIG. 4B is a diagram that illustrates an example of solar module placement in accordance with some aspects of the present disclosure.

FIG. 4C is a diagram that illustrates an example of solar module placement in accordance with some aspects of the present disclosure.

FIG. 4D is a diagram that illustrates an example of solar module placement in accordance with some aspects of the present disclosure.

FIG. 4E is a diagram that illustrates an example of solar module placement in accordance with some aspects of the present disclosure.

FIG. 4F is a diagram that illustrates an example of solar module placement in accordance with some aspects of the present disclosure.

FIG. 4G is a diagram that illustrates an example of solar module placement in accordance with some aspects of the present disclosure.

FIG. 4H is a diagram that illustrates an example of solar module placement in accordance with some aspects of the present disclosure.

FIG. 5 is a flow diagram of a method of solar module placement in accordance with some aspects of the present disclosure.

FIG. 6 illustrates a diagrammatic representation of a machine in an example form of a computer system that may perform one or more of the operations described herein in accordance with some aspects of the present disclosure.

### DETAILED DESCRIPTION

Various challenges exist with respect to installing solar modules in an under-construction solar farm or replacing/repairing solar modules in a solar farm. As indicated above, a solar farm may cover a relatively large geographic area, such as ten acres, one-hundred acres, etc., and thousands of solar modules may be installed in the solar farm. As such, labor used to construct a solar farm may be extensive. Technology has been developed to aid in installing solar modules; however, such technology suffers from various deficiencies. For instance, a torque bar may be located four to five feet above the ground in order to prevent wind damage to solar modules in the solar park. With more particularity, solar modules installed on a torque bar may form a relatively large surface area. If a torque bar is located too far above the ground, wind can cause the solar modules to be damaged (e.g., by ripping the solar modules off the torque bar). As such, a height of a robot for installing solar modules may be limited by a height of a torque bar. Furthermore, solar modules may be made of relatively fragile materials. As such, solar modules may be shipped and packaged vertically (i.e., the solar modules may rest on an edge face when shipped) to reduce a chance of damage during shipment; however, when installing a solar module, the solar module may be oriented horizontally (i.e., parallel or obliquely relative to the ground). Changing an orientation of thousands of solar modules from vertical to horizontal or oblique during installation may be cumbersome and time consuming. Furthermore, automated solutions for changing the orientation from vertical to horizontal may damage the solar modules. Additionally, automated technology for installing solar modules may not be perfect and may require visual inspection by a human to ensure that solar modules are installed properly.

The present disclosure addresses the above-noted and other deficiencies by disclosing a method of installing solar modules by a robotic vehicle. The robotic vehicle may be an autonomous robotic vehicle or a semiautonomous robotic vehicle. The robotic vehicle may have a height that is under five feet tall or a corresponding height of torque bars associated with a solar farm so as to enable the robotic vehicle to maneuver underneath the torque bars. The robotic vehicle includes a first arm and a second arm. The first arm may include a gripping component (e.g., suction cup(s)) and a first sensor. The second arm may include a fastening component (e.g., a screwdriver, a drill, etc.) and a second sensor (e.g., a depth camera). In an example, the first arm is located on a rear of the robotic vehicle and the second arm is located on a side of the robotic vehicle. In some embodiments, one or both of the first arm and the second arm could be provided on alternative locations.

The robotic vehicle may navigate to an installation site in a solar farm. The installation site may include a torque bar and one or more brackets for mounting the solar module. The robotic vehicle may identify a (to-be-installed) solar module via the first sensor. In an example, the solar module may be located in a package of solar modules stacked vertically (i.e., each solar module may rest on the ground or on a surface on a side face). The robotic vehicle may grip the solar module on a front face of the solar module with the first arm, where the front face includes solar cells (i.e., PV cells). The robotic vehicle may control the first arm to place the solar module above the torque bar such that a back face (i.e., a face opposite the front face) of the solar module is positioned proximate to the bracket of the torque bar. The back face of the solar module may include holes for mounting the solar module. The bracket may also include holes for mounting the solar module. In an example, the robotic vehicle, via the first arm, may position the solar module several inches above the bracket. The robotic vehicle may position the second arm to be located underneath the bracket of the torque bar. The robotic vehicle may obtain, via the second sensor, image data of the bracket. In an example, the second sensor may include a depth camera and the image data may be a point cloud. The robotic vehicle may translate the image data into a pose for the first arm. For instance, the robotic vehicle may identify (e.g., via a machine learning (ML) vision model) centroids of holes on the bracket and the robotic vehicle may translate the centroids into the pose for the first arm. The robotic vehicle may adjust the first arm based on the pose. After adjustment, holes on the back face of the solar module may be located above holes of the bracket. The robotic vehicle may secure the solar module to the bracket by a fastener via the second arm. For instance, the robotic vehicle may secure the solar module to the bracket via a huck bolt. The robotic vehicle may release the grip of the first arm on the solar module. The robotic vehicle may capture an image of the installation of the solar module for quality control purposes.

In an example, a method described herein includes gripping, via a first arm of the robotic vehicle, a front face of a solar module. The method includes placing, via the first arm of the robotic vehicle, the solar module above a torque bar such that a back face of the solar module is positioned proximate to a bracket of the torque bar. The method includes obtaining, via a sensor disposed in a second arm of the robotic vehicle as the second arm is located beneath the bracket of the torque bar, image data of the bracket. The method includes translating the image data of the bracket into a pose for the first arm gripping the solar module. The method includes adjusting at least one of a position or an orientation of the first arm based on the pose. The method includes securing, via the second arm as the second arm is located beneath the bracket, the back face of the solar module to the bracket by a fastener.

As discussed herein, the present disclosure provides an approach that improves installation of solar modules. For instance, as the robotic vehicle has a height that is less than five feet tall, the robotic vehicle may maneuver underneath torque bars in a solar farm. Furthermore, the aforementioned two-arm approach to installing a solar panel may result in proper installations that reduce, minimize, or avoid human intervention. Furthermore, the present disclosure does not require reorienting a package of solar modules from a vertical orientation to a horizontal orientation, which may reduce a chance of damage to a solar module during installation.

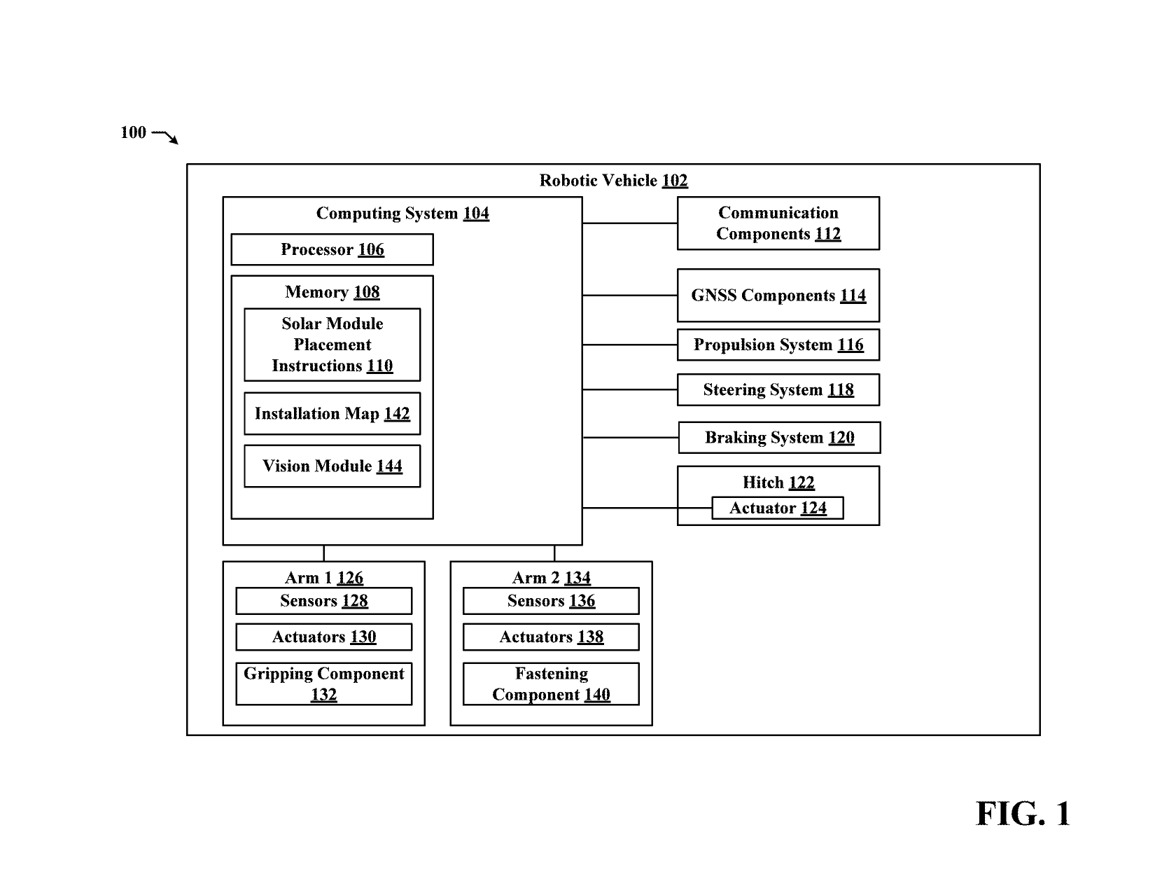

FIG. 1 is a block diagram 100 that illustrates an example of a robotic vehicle 102 for solar module placement in accordance with some aspects of the present disclosure. The robotic vehicle 102 may be an autonomous robotic vehicle (i.e., capable of operating without human intervention) or a semiautonomous robotic vehicle (i.e., capable of operating with some human intervention). The robotic vehicle 102 includes a computing system 104. The computing system 104 includes a processor 106 (e.g., a central processing unit (CPU), a graphics processing unit (GPU), etc.) and memory 108. The memory 108 may store solar module placement instructions 110 that, when executed by the processor 106, cause the robotic vehicle 102 to perform actions pertaining to installing solar modules as described herein. In some aspects, the robotic vehicle 102 may operate autonomously. In some aspects, the robotic vehicle 102 may be controlled by an operator (e.g., a human user) via a control mechanism (e.g., a controller). In some aspects, the robotic vehicle 102 may transition from being operated autonomously to being controlled by the operator via the control mechanism. For example, if the robotic vehicle 102, while operating autonomously, encounters an issue with installing a solar module, the robotic vehicle 102 may transition to being controlled by the operator in order to overcome the issue with installing the solar module. In some aspects, the robotic vehicle 102 may transition from being controlled by the operator via the control mechanism to being operated autonomously. For example, after the issue has been resolved, the robotic vehicle 102 may transition to operating autonomously.

The robotic vehicle 102 may include communication components 112 that are communicatively coupled to, controlled by, and/or included in the computing system 104. The communication components 112 enables the robotic vehicle 102 to communicate with devices, such as other robotic devices, servers, smartphones, desktop computing devices, laptop computing devices, tablet computing devices, etc. In an example, the communication components 112 may be or include a Bluetooth® radio, a wireless local area network (WLAN) radio, a cellular radio, a satellite radio, etc.

The robotic vehicle 102 may include global navigation satellite system (GNSS) components 114 that are communicatively coupled to, controlled by, and/or included in the computing system 104. The GNSS components 114 may enable the robotic vehicle 102 to ascertain a geographic position (e.g., a latitude and a longitude) of the robotic vehicle 102 via signals received from satellites. In an example, the GNSS components 114 may include a global positioning system (GPS) receiver and/or a Starlink® receiver.

The robotic vehicle 102 may include a propulsion system 116 that is communicatively coupled to and controlled by the computing system 104. The propulsion system 116 may enable the robotic vehicle 102 to move around an environment (e.g., an under-construction solar farm). The propulsion system 116 may include an engine and/or a motor, a gearbox, wheels, and axels. The propulsion system 116 can be associated with a fuel source, which may include one or more of a combustible chemical fuel (e.g., gasoline, diesel fuel, biofuel), stored electrical energy device (e.g., chemical batteries, lithium-ion batteries, fuel cells, etc.), or other energy source suitable for driving components of the propulsion system 116. In some embodiments, an energy/fuel source associated with the propulsion system 116 can provide electrical power to one or more other components of the robotic vehicle 102.

The robotic vehicle 102 may include a steering system 118 that is communicatively coupled to and controlled by the computing system 104. The steering system 118 enables the robotic vehicle 102 to change a direction of the robotic vehicle 102 as the robotic vehicle 102 is moving.

The robotic vehicle 102 may include a braking system 120 that is communicatively coupled to and controlled by the computing system 104. The braking system 120 enables the robotic vehicle 102 to reduce a velocity of the robotic vehicle 102 and/or stop motion of the robotic vehicle 102. The braking system 120 may include a brake booster, brake fluid, brake calipers, and brake pads.

The robotic vehicle 102 may include a hitch 122. The hitch 122 may be located on a back end of the robotic vehicle 102. The hitch 122 may enable the robotic vehicle 102 to tow an object, such as a wagon that carries solar modules. The hitch 122 may be connected to an actuator 124. The actuator 124 may be communicatively coupled to and controlled by the computing system 104. In an example, the actuator 124 may be or include a pneumatic actuator, a hydraulic actuator, or an electric actuator. As will be described in greater detail below, the actuator 124 may enable the robotic vehicle to adjust an angle of solar modules oriented vertically in a package.

The robotic vehicle 102 may include a first arm 126. The first arm 126 may be communicatively coupled to and controlled by the computing system 104. As will be described in greater detail below, the first arm 126 may be responsible for gripping solar modules and placing solar modules on top of a torque bar during installation.

The first arm 126 may include sensors 128. The sensors 128 may be communicatively coupled to and controlled by the computing system 104. The sensors 128 may be or include a camera, a depth camera, a video camera, a radar sensor, a light detection and ranging (Lidar) sensor, a pressure sensor, a force sensor, a torque sensor, etc. The sensors 128 may generate sensor data that enables the robotic vehicle 102 to identify a solar module, grip the solar module, and place the solar module on top of a torque bar.

The first arm 126 may include actuators 130. The actuators 130 may be communicatively coupled to and controlled by the computing system 104. In an example, the actuators 130 may be or include a pneumatic actuator, a hydraulic actuator, or an electric actuator. As will be described in greater detail below, the actuators 130 may enable the first arm 126 to grip solar modules and place solar modules on top of a torque bar during installation.

The first arm 126 may include a gripping component 132 that enables the robotic vehicle to grip a solar module during installation. In an example, the gripping component 132 may be or include suction cup(s) that use negative fluid pressure from air to adhere to a nonporous surface of a solar module. In some embodiments, the gripping component 132 can include one or more vacuum line(s) associated with the suction cup(s) to create/induce a vacuum pressure. In other embodiments, a different modality of gripping a surface or other portion of a solar module could be provided.

The robotic vehicle 102 may include a second arm 134. The second arm 134 may be located on the robotic vehicle 102 perpendicular to the first arm 126. For instance, the second arm 134 may be located on a side of the robotic vehicle 102 and the first arm 126 may be located at a rear of the robotic vehicle 102. The second arm 134 may be communicatively coupled to and controlled by the computing system 104. As will be described in greater detail below, the second arm 134 may be responsible for gathering data used to align holes of a solar module with holes of a bracket on a torque bar. The second arm 134 may also be responsible for fastening the solar module to the bracket via a fastener (e.g., a huck bolt).

The second arm 134 may include sensors 136. The sensors 136 may be communicatively coupled to and controlled by the computing system 104. The sensors 136 may be or include a camera, a depth camera, a video camera, a radar sensor, a Lidar sensor, a pressure sensor, a force sensor, a torque sensor, etc. The sensors 136 may generate sensor data that enables the robotic vehicle 102 to determine a position of a bracket on a torque bar and use the position to adjust a pose of the first arm 126 as the first arm 126 grips a solar panel such that holes of the solar panel are positioned over holes of the bracket.

The second arm 134 may include actuators 138. The actuators 138 may be communicatively coupled to and controlled by the computing system 104. In an example, the actuators 138 may be or include a pneumatic actuator, a hydraulic actuator, or an electric actuator. As will be described in greater detail below, the actuators 138 may enable the robotic vehicle 102 to position the second arm 134 underneath a torque bar. The actuators 138 may also enable the robotic vehicle 102 to fasten a solar module to a bracket of a torque bar.

The second arm 134 may include a fastening component 140 (e.g., a fastening tool). The fastening component 140 may be communicatively coupled to and controlled by the computing system 104. The fastening component 140, when controlled by the computing system 104, may fasten a solar panel to a bracket via a fastener.

In some aspects, the first arm 126 and/or the second arm 134 may include a plurality of segments. A segment in the plurality of segments is connected to at least one other segment in the plurality of segments. In some aspects, each segment may be capable of independent movement, for example, so as to be arranged for one or more of eccentric motion, concentric motion, extension, retraction, telescoping, etc. The first arm 126 may thus incorporate one or more joints, linkages, other couplings, etc., in cooperation with the actuators 138 to effect such movement.

In some aspects, the first arm 126 and/or the second arm 134 may operate in an autonomous mode. When operating in the autonomous mode, the first arm 126 and/or the second arm 134 may work together to install a solar panel without being controlled by a human operator. In some aspects, the first arm 126 and/or the second arm 134 may operate in a zero gravity (Zero-G) assist mode. When operating in the Zero-G assist mode, operation of the first arm 126 and/or the second arm 134 may be overridden by a human operator via a hand (i.e., the human operator may manually move the first arm 126 and/or the second arm 134), by a control fixed to the first arm 126 and/or the second arm 134 (i.e., the human operator may utilize the control to move the first arm 126 and/or the second arm 134), and/or by a wireless controller (i.e., the human operator may utilize the wireless controller to move the first arm 126 and/or the second arm 134) such that the human operator may direct operation of the first arm 126 and/or the second arm 134 to install a solar module. The Zero-G assist mode may be used in circumstances (e.g., unusual circumstances) in which installing solar modules via the autonomous mode is difficult. In some aspects, the robotic vehicle 102 may dynamically switch from operating the first arm 126 and/or the second arm 134 in the autonomous mode to operating the first arm 126 and/or the second arm 134 in the Zero-G assist mode or dynamically switch from operating the first arm 126 and/or the second arm 134 in the Zero-G assist mode to operating the first arm 126 and/or the second arm 134 in the autonomous mode.

In such aspects, the gripping component 132 may be located on an end segment of a plurality of segments of the first arm 126, that is, the gripping component 132 may be connected to one segment. In such aspects, the fastening component 140 may be located on an end segment of a plurality of segments of the second arm 134, that is, the fastening component 140 may be connected to one segment. In some aspects, a sensor (e.g., a depth camera) in the sensors 136 may be disposed in a same segment as the fastening component 140.

In some aspects, the robotic vehicle 102 may include a compartment in which some or all of the first arm 126 may be stored so as to reduce a profile of the robotic vehicle 102 when the robotic vehicle travels. Alternatively, the first arm 126 may be folded onto a side of the robotic vehicle 102 to reduce a profile of the robotic vehicle 102. When the first arm 126 is located partially or entirely in the compartment or folded on the side of the robotic vehicle 102, the first arm 126 may be referred to as non-extended. When the robotic vehicle 102 is to perform functionality using the first arm 126, the robotic vehicle 102 may extend the first arm 126 from the compartment or the robotic vehicle 102 may unfold the first arm 126 from the side of the robotic vehicle to perform the functionality.

In some aspects, the robotic vehicle 102 may include a compartment in which some or all of the second arm 134 may be stored so as to reduce a profile of the robotic vehicle 102 when the robotic vehicle travels. Alternatively, the second arm 134 may be folded onto a side of the robotic vehicle 102 to reduce a profile of the robotic vehicle 102. When the second arm 134 is located partially or entirely in the compartment or folded on the side of the robotic vehicle 102, the second arm 134 may be referred to as non-extended. When the robotic vehicle 102 is to perform functionality using the second arm 134, the robotic vehicle 102 may extend the second arm 134 from the compartment or the robotic vehicle 102 may unfold the second arm 134 from the side of the robotic vehicle to perform the functionality.

Although the first arm 126 is described above as including a gripping component 132, such as a suction cup for gripping or a different modality for gripping, other possibilities are contemplated. For example, the first arm 126 may include a quick attach slot on an end of the first arm 126 that enables different tool type(s) (e.g., different sizes of suction cups, different types of gripping mechanisms, cleaning tools such as a brush or spraying mechanism, a tool to apply a protective coating to a solar module, etc.) to be quickly switched in and out of the first arm 126 either automatically by the robotic vehicle 102 (e.g., by detaching a currently attached tool from the first arm into a storage unit on or near the robotic vehicle 102 for storing tools and by attaching a new tool from the storage unit) or manually by a human operator. The robotic vehicle 102 may then perform actions (e.g., installing a solar module, cleaning a solar module, applying a protective coating, etc.) with the first arm 126 using a newly attached tool. Additionally or alternatively, the second arm 134 may include a quick attach slot on an end of the second arm 134 that enables different tool type(s) (e.g., different types of fastening tools, cleaning tools such as a brush or spraying mechanism, a tool to apply a protective coating to a solar module, etc.) to be quickly switched in and out of the second arm 134 either automatically by the robotic vehicle 102 (e.g., by detaching a currently attached tool from the first arm into a storage unit on or near the robotic vehicle 102 for storing tools and by attaching a new tool from the storage unit) or manually by a human operator. The robotic vehicle 102 may then perform actions (e.g., installing a solar module, cleaning a solar module, applying a protective coating, etc.) with the second arm 134 using a newly attached tool.

The memory 108 of the computing system 104 may include an installation map 142 of a solar farm. The installation map 142 may indicate locations of brackets on torque bars in an under-construction solar farm. The robotic vehicle 102 may utilize the installation map 142 in conjunction with the GNSS components 114 and/or the communication components 112 to travel around the under-construction solar farm relative to structures, markers, or other location information associated with the installation map 142.

The memory 108 of the computing system 104 may include a vision module 144. The vision module 144 may include models (e.g., machine learning (ML) models, artificial intelligence (AI) models, etc.) and algorithms that may enable the robotic vehicle 102 to perceive and interpret surroundings of the robotic vehicle 102. For example, the robotic vehicle 102 may obtain sensor data (e.g., from the sensors 128, from the sensors 136) or other data (e.g., from the communication components 112, from the GNSS components 114, etc.) and provide the aforementioned data as input to the vision module 144. The vision module 144 may then determine characteristics of an environment of the robotic vehicle 102 based on an output of the vision module 144. In an example, the vision module 144 may enable the robotic vehicle 102 to identify a solar module, determine a location at which to place a solar module over a torque bar, identify holes in a bracket on a torque bar and/or holes on the solar module, determine that solar panel has been secured to the bracket, etc.

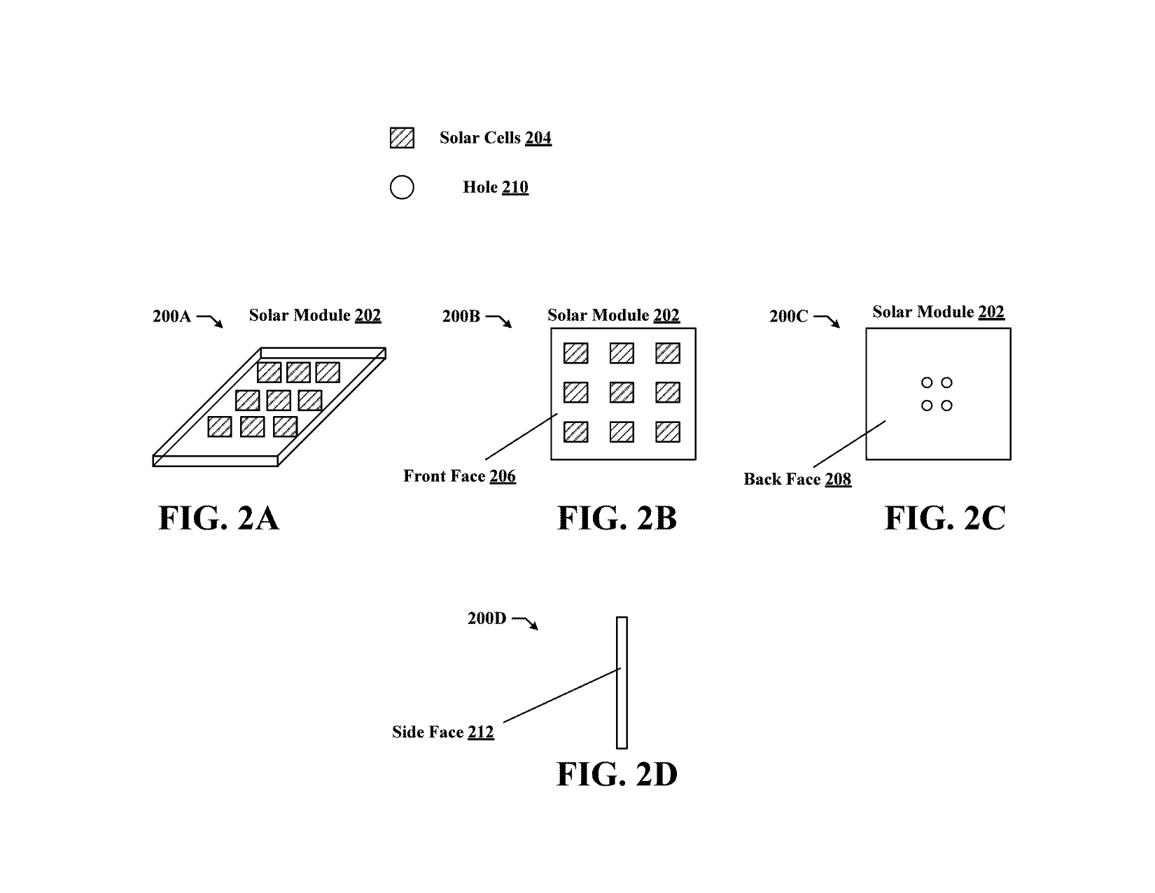

FIG. 2A is a diagram 200A that illustrates an example view of a solar module 202 in accordance with some aspects of the present disclosure. The solar module 202 may include solar cells 204. The solar cells 204 are made of materials that produce excited electronics when exposed to light. The electrons flow through a circuit and produce DC electricity, which can be used to power devices or which can be stored in a battery. In some aspects, the solar cells 204 include wafer-based crystalline silicon cells or thin-film cells. Although not depicted in the diagram 200A, the solar module 202 may include an inverter that converts DC electricity to alternating current (AC) electricity. The solar module 202 may also include a controller, a meter, and/or a tracker.

FIG. 2B is a diagram 200B that illustrates an example view of the solar module 202 in accordance with some aspects of the present disclosure. The view depicted in the diagram 200B illustrates a front face 206 of the solar module 202. As used herein, the term “front face” with respect to a solar module refers to a side of the solar module in which solar cells are disposed.

FIG. 2C is a diagram 200C that illustrates an example view of the solar module 202 in accordance with some aspects of the present disclosure. The view depicted in the diagram 200C illustrates a back face 208 of the solar module 202. As used herein, the term “back face” with respect to a solar module refers to a side of the solar module opposite that of a front face of a solar module and that includes holes 210 for securing the solar panel to a torque bar. The holes 210 may or may not extend throughout a depth of the solar module 202. For instance, the holes 210 may extend through a portion (but not an entirety) of a depth of the solar module 202.

FIG. 2D is a diagram 200D that illustrates an example view of a solar module in accordance with some aspects of the present disclosure. The view depicted in the diagram 200D illustrates a side face 212 of the solar module 202. As used herein, the term “side face” with respect to a solar module refers to a side of a solar panel that is not a front face or a back face. A measurement in inches of a side face may be generally less than a measurement in inches of a front face or a back face.

Referring generally now to FIG. 2A, FIG. 2B, FIG. 2C, and FIG. 2D, in some aspects, an area of the front face 206 and an area of the back face 208 may be defined by a length and a width of the solar module 202. In an example, the length be 78 inches and the width may be 39 inches wide. In some aspects, an area of the side face 212 may be defined by a depth of the solar module 202 and the length of the solar module 202 or the area of the side face 212 may be defined by the depth of the solar module 202 and a width of the solar module 202. In an example, the depth may be 1.5 – 2 inches, though one or more dimensions of the solar module 202 could be different without departing from the disclosure.

Although FIG. 2A, FIG. 2B, FIG. 2C, and FIG. 2D depict and describe the solar module 202 as rectangular, other possibilities are contemplated. In some aspects, the solar module 202 may be circular, triangular, hexagonal, etc. so long as the solar module 202 includes a front face, a back face, and at least one side face.

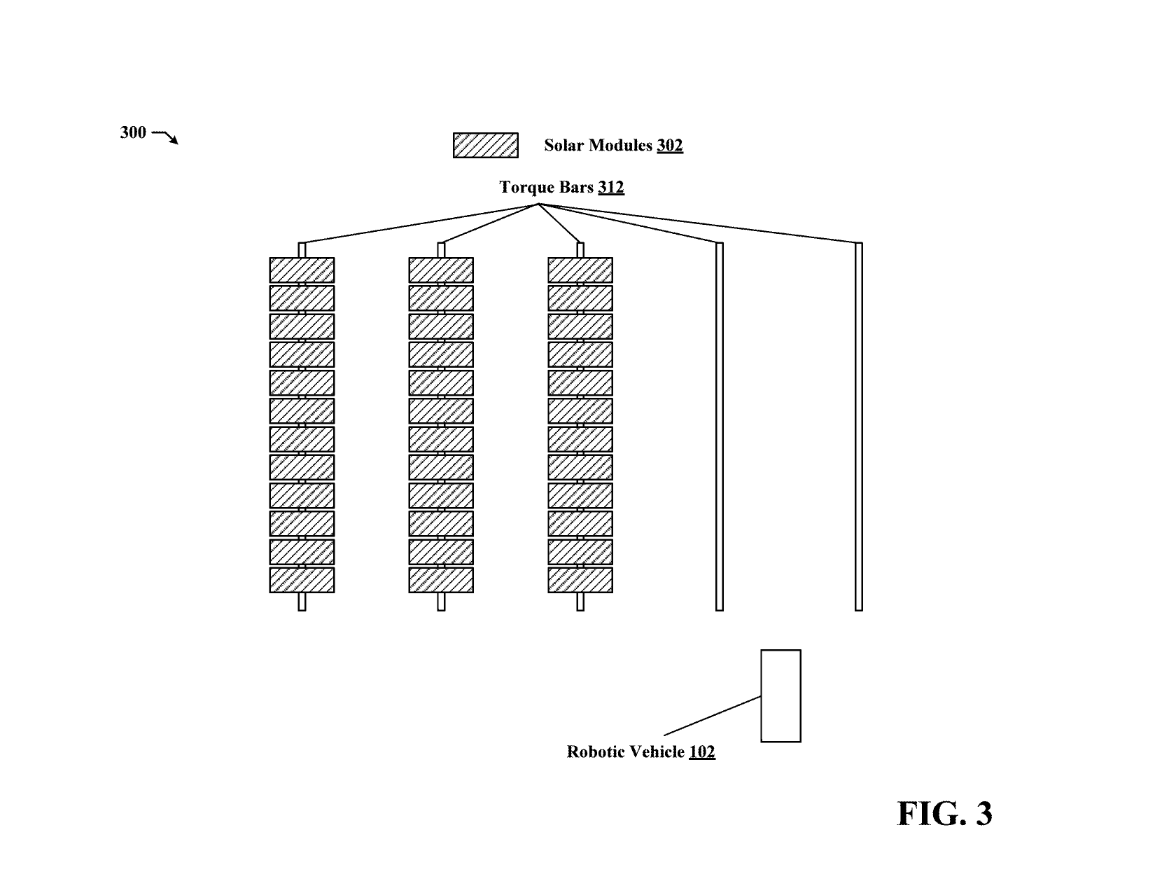

FIG. 3 is a diagram 300 that illustrates an example of an under-construction solar farm in accordance with some aspects of the present disclosure. In some embodiments, such solar farm could be a completed installation undergoing maintenance and/or repair. As depicted in the diagram 300, the solar farm includes solar modules 302 installed on torque bars 312, where the torque bars 312 are oriented parallel to one another in rows. In an example, the solar modules 302 may include the solar module 202. The solar modules 302 may be positioned on the torque bars 312 approximately five feet from the ground. As depicted in the diagram 300, the robotic vehicle 102 is about to enter a row that has not yet had solar modules installed.

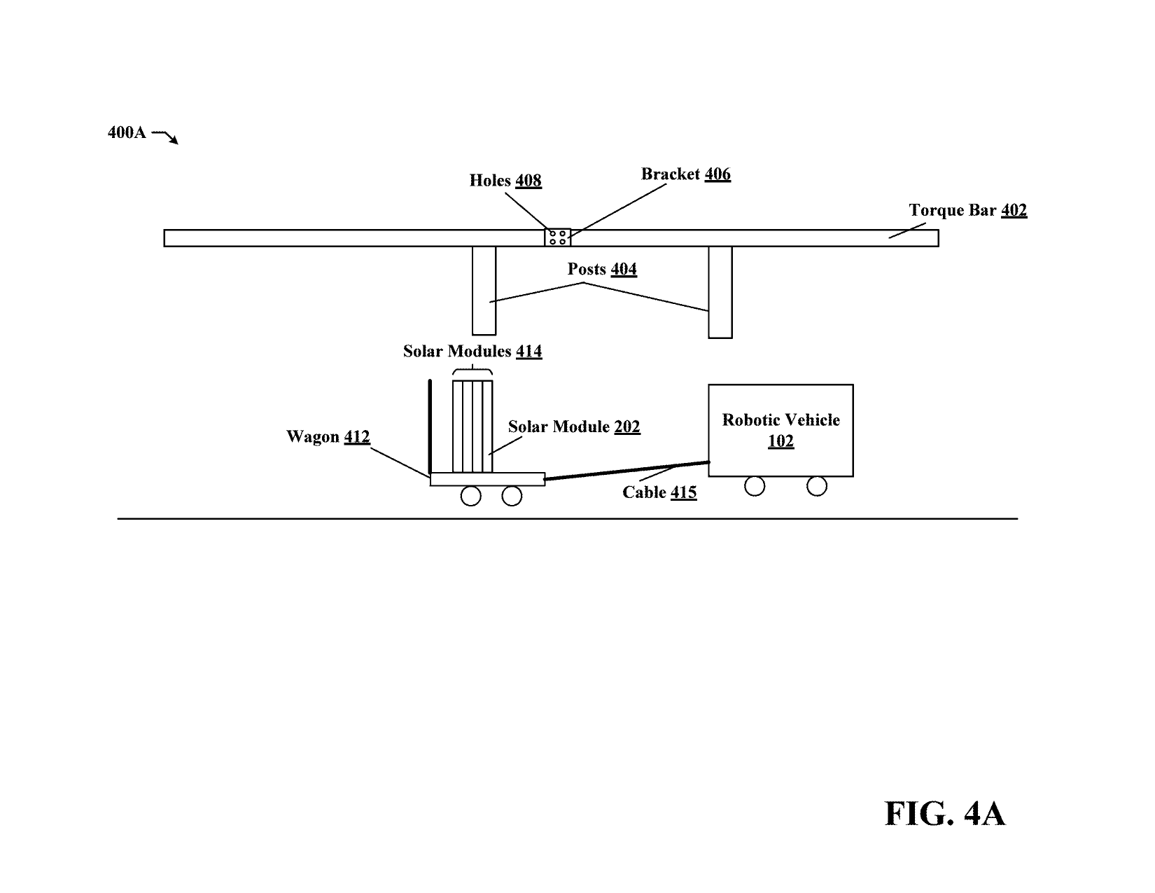

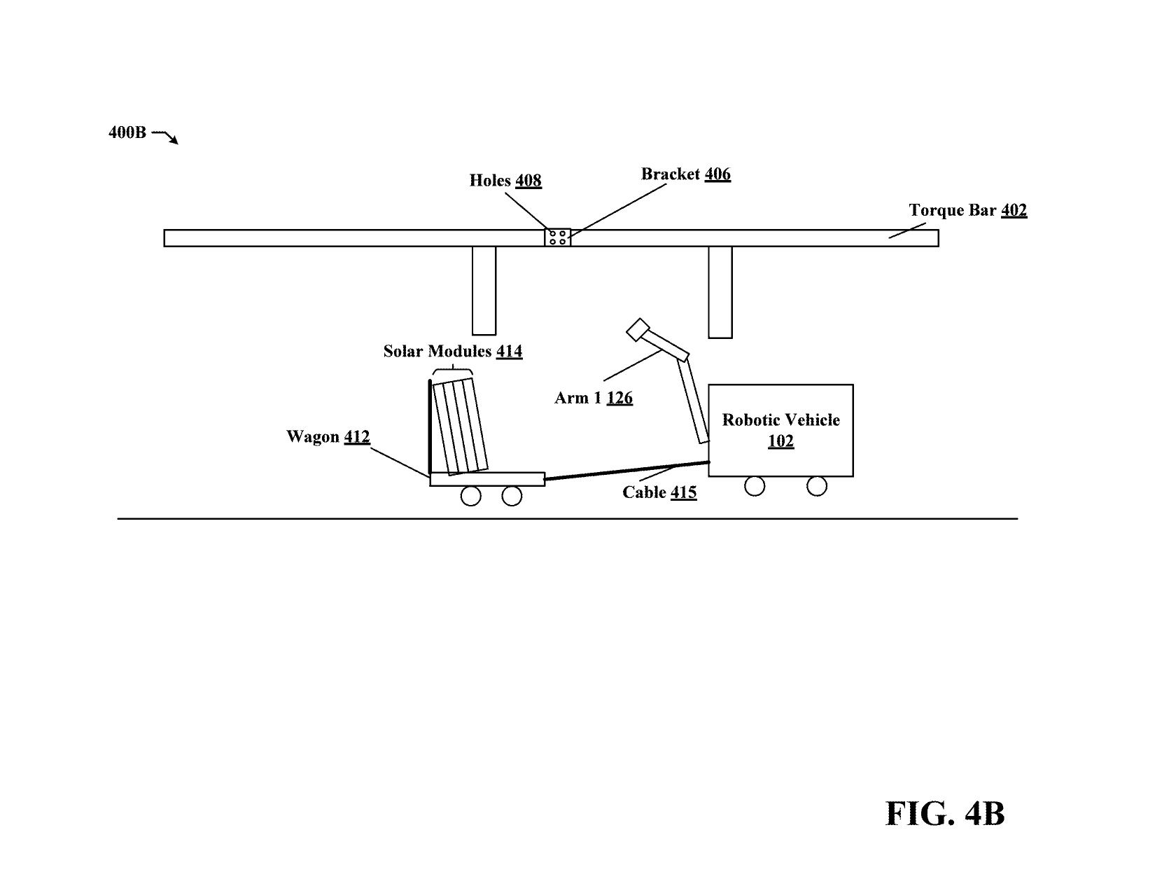

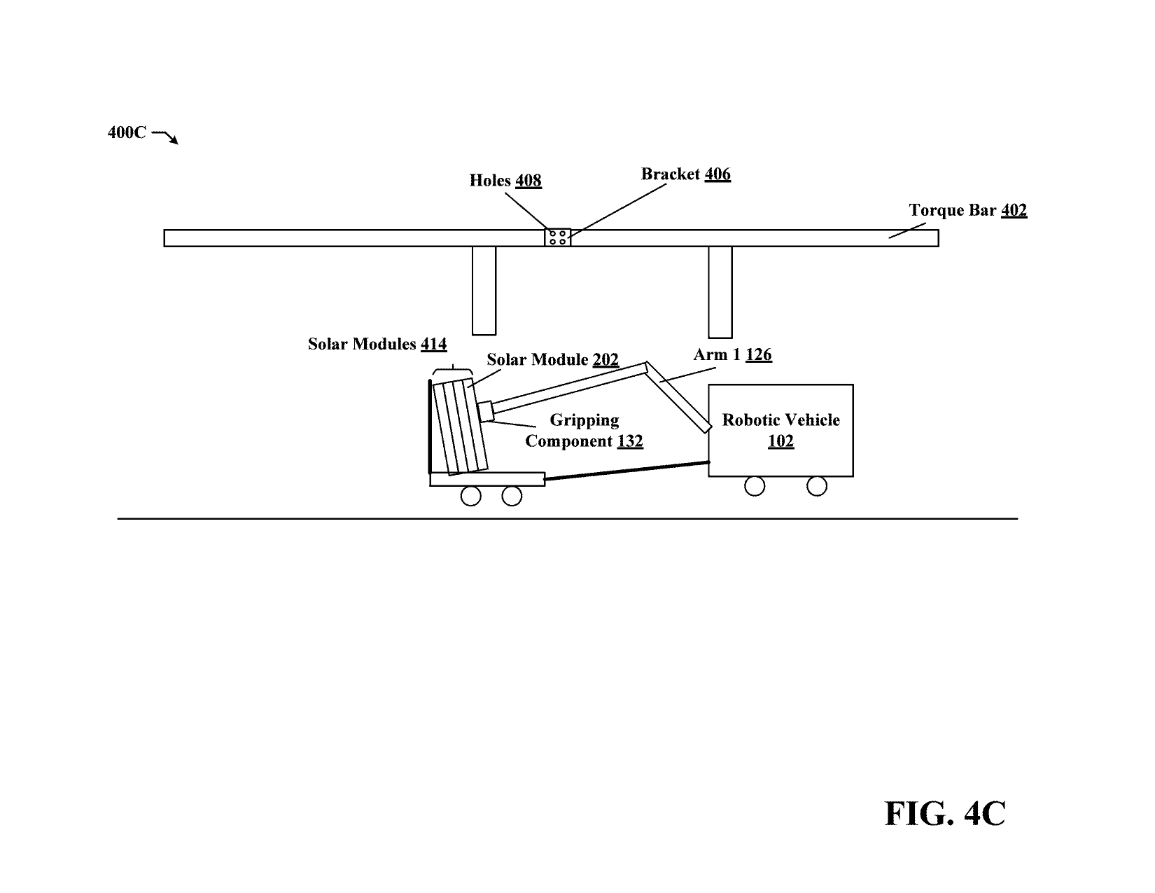

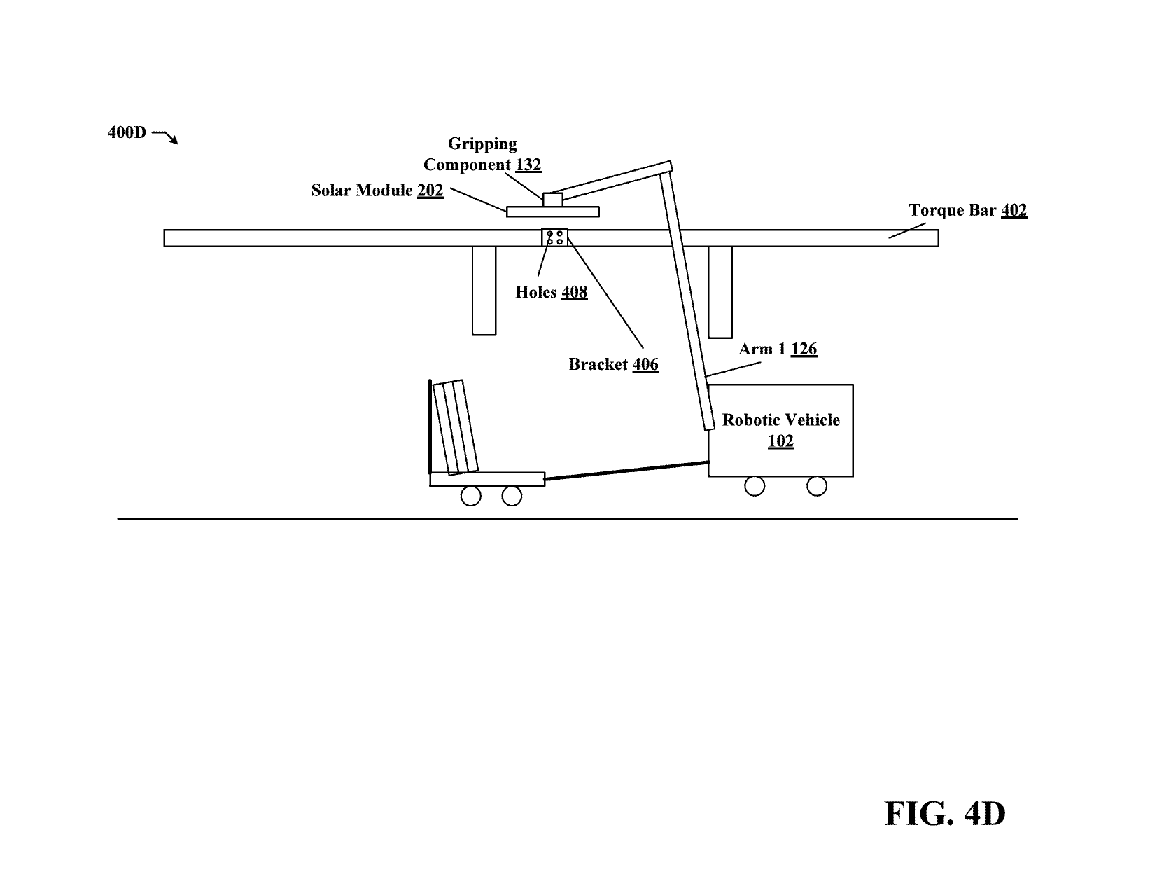

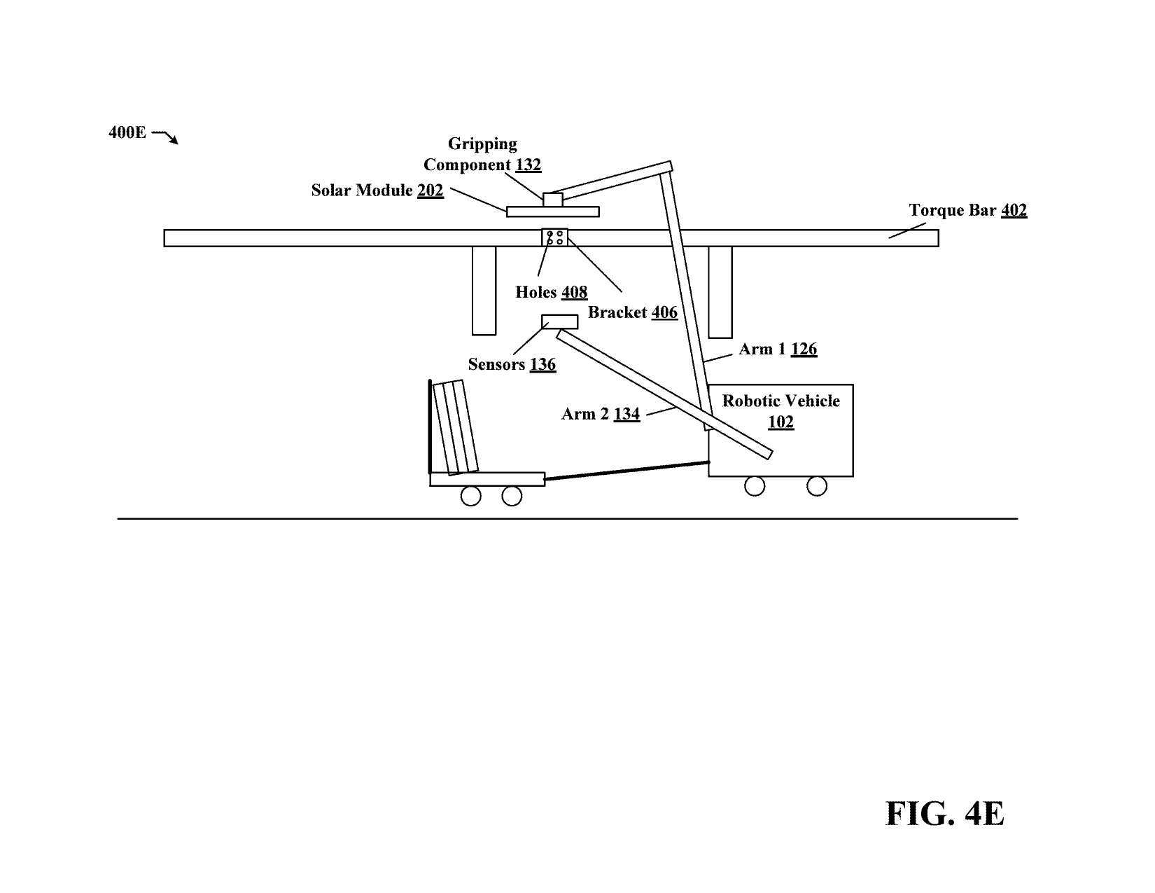

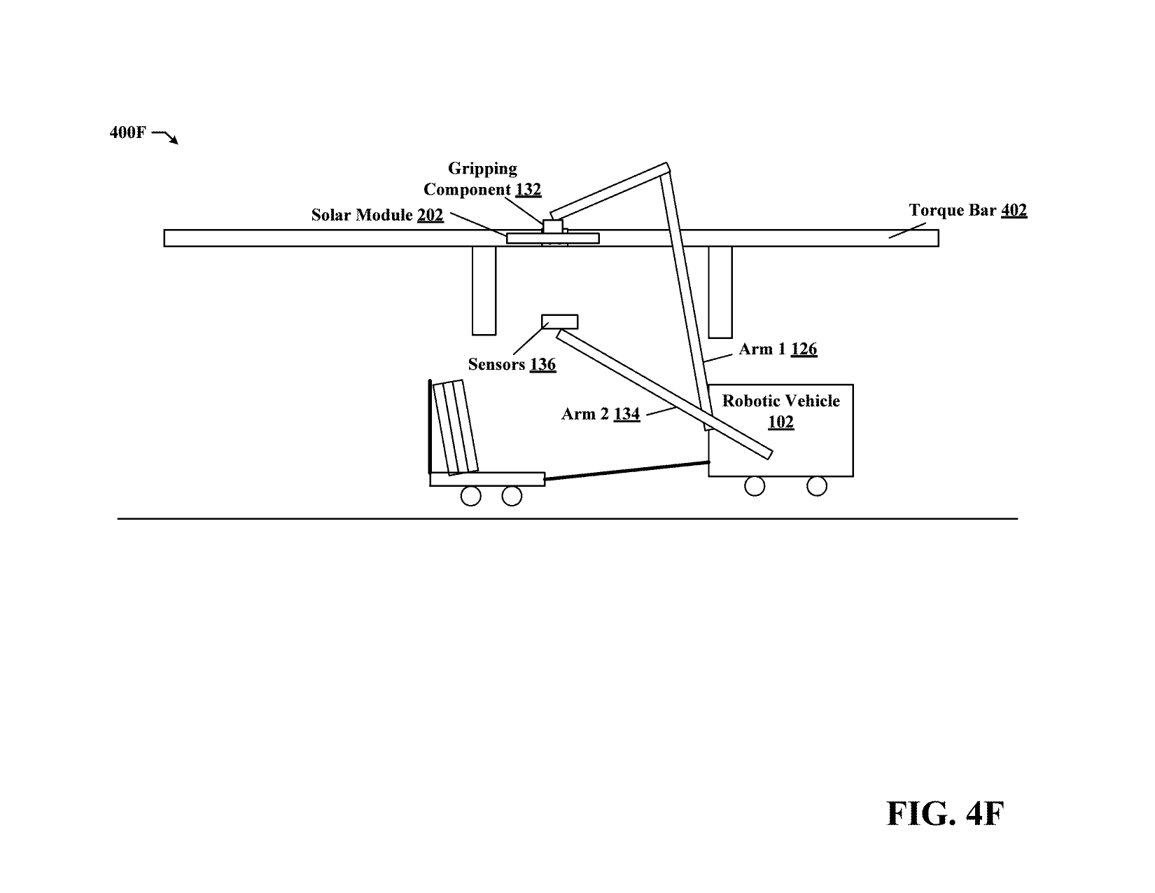

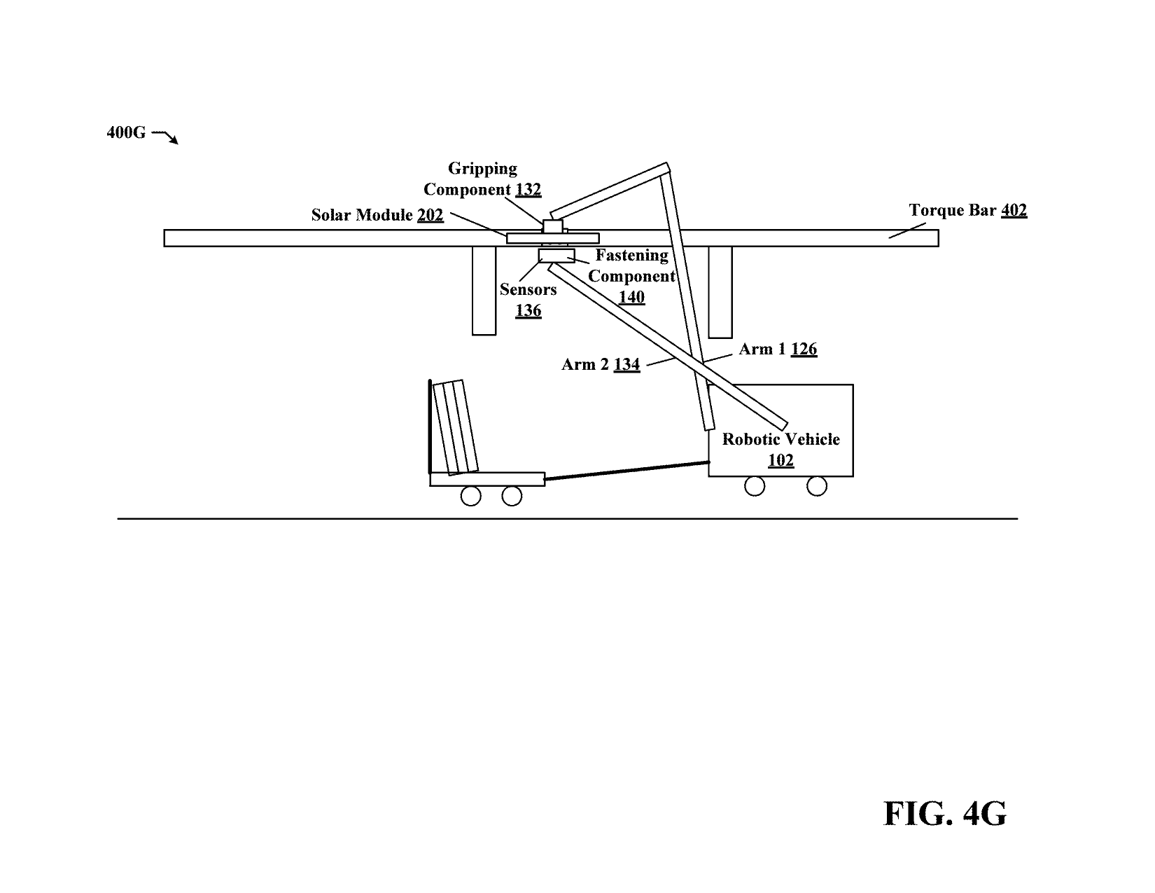

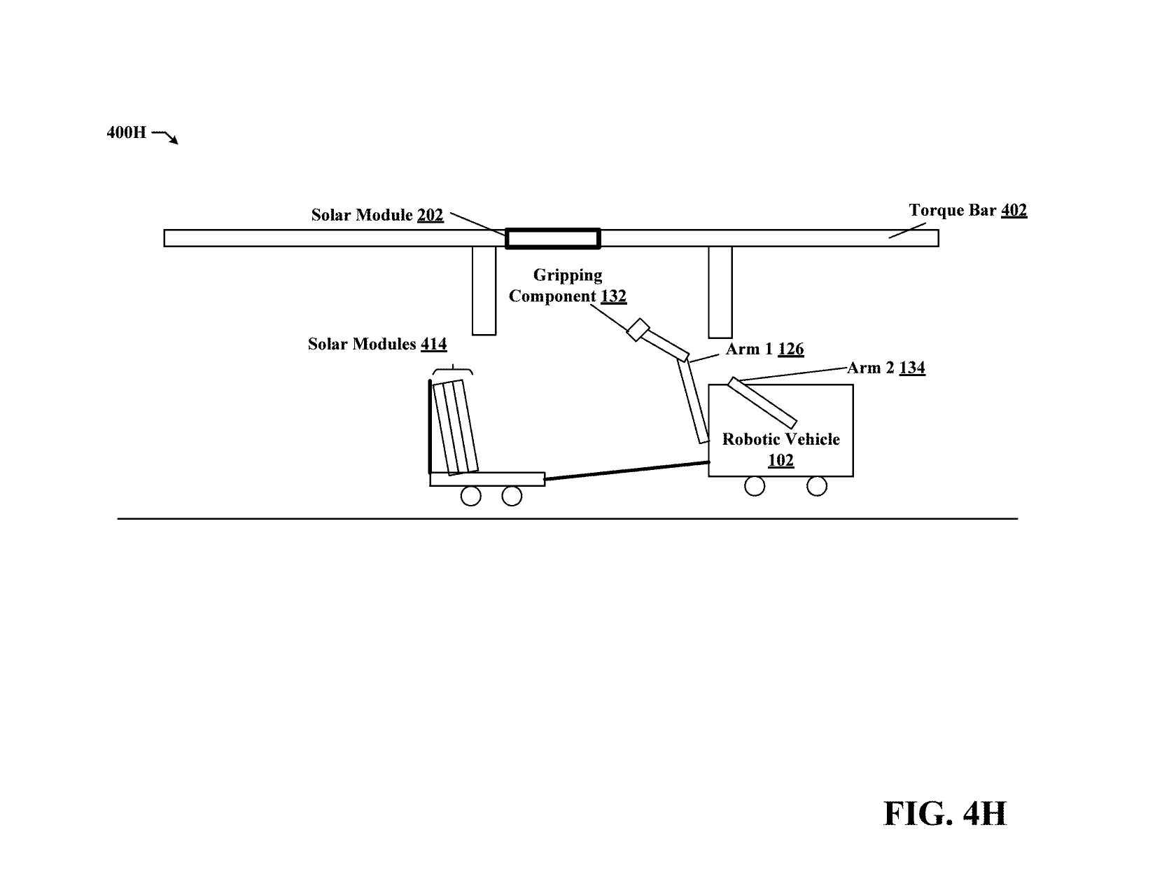

FIG. 4A is a diagram 400A that illustrates an example of solar module placement in accordance with some aspects of the present disclosure. As depicted in the diagram 400A, the robotic vehicle 102 is moving in a row of an under-construction or under-maintenance solar park. The robotic vehicle 102 is located proximate to a torque bar 402 that is supported by posts 404. In an example, the torque bar 402 is located five feet above the ground. The torque bar 402 includes a bracket 406 that includes holes 408 for installing a solar module. In an example, the torque bar 402 may be a torque bar forming a portion of or extending from the torque bars 312.

The robotic vehicle 102 may tow a wagon 412 via a cable 415. A first end of the cable may connect to the wagon 412 and a second end of the cable 415 may connect to the hitch 122 (not depicted in FIG. 4A). The wagon 412 may carry solar modules 414, where the solar modules 414 includes the solar module 202. The solar modules 414 may be stacked vertically in the wagon 412, that is, each solar module in the solar modules 414 may rest on a side face on a surface of the wagon 412.

FIG. 4B is a diagram 400B that illustrates an example of solar module placement in accordance with some aspects of the present disclosure. In the diagram 400B, the robotic vehicle 102 has arrived at an installation site for the solar module 202. If the first arm 126 is non-extended, the robotic vehicle 102 may extend the first arm 126. The robotic vehicle 102 may adjust a tension in the cable 415 via the actuator 124. In an example, the robotic vehicle 102 may adjust the tension in the cable 415 such that the solar modules 414 now rest at angle, for example, so as to take up empty space atop the wagon 412 and avoid tipping, shifting, or other unwanted movement of the solar modules 414 so as to reduce a risk of the solar modules 414 becoming damaged during installation. A top portion of a solar module located nearest a back of the wagon 412 may contact the back of the wagon 412 to prevent the solar modules 414 from sliding. In an example, the angles is less than 15°, such as 5-10°.

FIG. 4C is a diagram 400C that illustrates an example of solar module placement in accordance with some aspects of the present disclosure. Subsequent to changing the angle of the solar modules 414, the robotic vehicle 102 may identify the solar module 202 (e.g., via the sensors 128, such as a camera, a depth camera, a Lidar sensor, etc.). In an example, the robotic vehicle 102 identifies a central region of the solar module 202. The robotic vehicle 102 extends the first arm 126 towards the solar module 202 such that the gripping component 132 of the first arm 126 makes contact with the solar module 202 (e.g., at the central location). The robotic vehicle 102 grips (e.g., via suction cup(s)) the solar module 202 via the gripping component 132. In some aspects, the robotic vehicle 102 determines that the grip is sufficient to hold the solar module 202 based on data from a pressure sensor in the sensors 128.

FIG. 4D is a diagram 400D that illustrates an example of solar module placement in accordance with some aspects of the present disclosure. Subsequent to gripping the solar module 202, and as the solar module 202 remains gripped by the gripping component 132, the robotic vehicle 102 causes the first arm 126 to move such that the back face 208 of the solar module 202 is located proximate to the holes 408 of the bracket 406 on the torque bar 402. In an example, the back face 208 of the solar module 202 is located several inches from the holes 408. The robotic vehicle 102 may determine a position and/or an orientation for the gripping component 132 and/or the first arm 126 based sensor data from the sensors 128. The robotic vehicle 102 may stop movement of the gripping component 132 and/or the first arm 126 when the gripping component 132 and/or the first arm 126 are at the position and/or the orientation. In some aspects, determining the position and/or the orientation may additionally be based on the installation map 142 and/or the GNSS components 114.

FIG. 4E is a diagram 400E that illustrates an example of solar module placement in accordance with some aspects of the present disclosure. Subsequent to moving the first arm 126 such that the back face 208 of the solar module 202 is located proximate to the holes 408 of the bracket 406 on the torque bar 402, the robotic vehicle 102 may move the second arm 134 underneath the holes 408 of the bracket 406 on the torque bar 402. The robotic vehicle 102 may obtain image data of the bracket 406. In an example, the sensors 136 of the second arm 134 include a depth camera that captures a depth image of the holes 408 of the bracket 406.

The robotic vehicle 102 translates the image data (e.g., the depth image, a point cloud, etc.) into a pose for the first arm 126 as the first arm 126 grips the solar module 202. For instance, the robotic vehicle 102 may identify centroids of the holes 408 based on the depth image and the robotic vehicle 102 may determine the pose based on the centroids. In some aspects, translating the image data into the pose may be performed in part by the vision module 144.

FIG. 4F is a diagram 400F that illustrates an example of solar module placement in accordance with some aspects of the present disclosure. Subsequent to translating the image data into the pose for the first arm 126, the robotic vehicle 102 may adjust a position and/or an orientation of the first arm 126 (and/or the gripping component 132) such that the holes 408 (not depicted in FIG. 4F) of the bracket 406 (not depicted in FIG. 4F) align with the holes 210 of the solar module 202. In some aspects, the robotic vehicle 102 confirms that the holes 408 align with the holes 210 via sensor data from the sensors 136.

FIG. 4G is a diagram 400G that illustrates an example of solar module placement in accordance with some aspects of the present disclosure. Subsequent to adjusting the position and/or the orientation of the first arm 126 (and/or the gripping component 132), the robotic vehicle 102 may move the second arm 134 such that the fastening component 140 of the second arm 134 is located proximate to the holes 408 (not depicted in FIG. 4G) of the bracket 406 (not depicted in FIG. 4G). Moving the second arm 134 may be based on sensor data from the sensors 136. The robotic vehicle 102 may fasten the solar module 202 to the bracket 406 via the fastening component 140 by fastener(s) that extend through the holes 408 and the holes 210. In some aspects, the fastener(s) may be stored in a compartment of the fastening component 140, the robotic vehicle 102 may extract the fastener(s) from the compartment, and the fastening component 140 may fasten the back face 208 of the solar module 202 to the bracket 406 via the extracted fastener(s). In an example, the fastener(s) may be or include a huck bolt.

FIG. 4H is a diagram 400H that illustrates an example of solar module placement in accordance with some aspects of the present disclosure. Subsequent to fastening the solar module 202 to the bracket 406 of the torque bar 402, the robotic vehicle 102 may cause the gripping component 132 to release the grip on the solar module 202. The robotic vehicle 102 may capture an image of the solar module 202 (e.g., via the sensors 128, the sensors 136, or other sensors of the robotic vehicle 102). The robotic vehicle 102 may store the image in the memory 108 (or other data storage) and/or the robotic vehicle 102 may transmit the image to a computing device via the communication components 112. In some aspects, the robotic vehicle 102 may then move the first arm 126 and/or the second arm 134 into a non-extended position. The robotic vehicle 102 may travel to a next installation site to install additional solar modules of the solar modules 414 in a manner similar to that described above with respect to the solar module 202.

Although the description of FIGS. 4A-4H describes the robotic vehicle 102 as carrying the solar modules 414 in the wagon 412, other possibilities are contemplated. In some aspects, the robotic vehicle 102 may include a gripping/lifting mechanism (e.g., pallet fork(s)). In such aspects, the robotic vehicle 102 may not include the wagon 412. The robotic vehicle 102 may locate the solar modules 414 either autonomously or by being manually controlled by a human operator. For example, the robotic vehicle 102 may have access to a map that includes a location of a pallet (or a crate) that includes the solar modules 414. The robotic vehicle 102 may navigate to the location based on the map and sensor data of the robotic vehicle 102. After arriving at the location, the robotic vehicle 102 may lift the pallet including the solar modules 414 via the gripping/lifting mechanism onto a surface of the robotic vehicle 102 and carry the pallet including the solar modules 414 to an area where the solar modules 414 are to be installed. The robotic vehicle 102 may then install the solar modules 414 in a manner similar to that described above in the description of FIGS. 4A-4H, without utilizing the wagon 412. For example, the robotic vehicle 102 may grip the solar module 202 via the firm arm 126 from the surface of the robotic vehicle 102 (as opposed to gripping the solar module 202 from the wagon) and install the solar module 202 as described above.

Although the robotic vehicle 102 is described above as including two arms (the first arm 126 and the second arm 134), other possibilities are contemplated. In some aspects, the robotic vehicle 102 includes the first arm 126 and not the second arm 134. In such aspects, the robotic vehicle 102 may navigate to an installation site for the solar module 202 as in FIG. 4A. A human operator (or operators) may be present alongside the robotic vehicle 102. The robotic vehicle 102 may grip the solar module 202 (e.g., as in FIG. 4C or as in the wagon-less aspect described above). The robotic vehicle 102 may place the solar module 202 over the bracket 406 as in FIG. 4D. The robotic vehicle 102 may then place the first arm 126 into the Zero-G assist mode described above. The human operator may then move the first arm 126 into a position near the bracket 406 such that the solar module 202 is aligned with the holes 408 of the bracket 406 (e.g., as in FIG. 4F). The human operator may then fasten the solar module 202 to the bracket 406 with a tool. The robotic vehicle 102 may then navigate to an installation site for the next solar module (e.g., the next bracket on the torque bar 402). Such functionality may be useful in scenarios in which terrain of a solar park is not conducive to utilizing both the first arm 126 and the second arm 134.

In some aspects, the robotic vehicle 102 includes the second arm 134 and not the first arm 126. In such aspects, the robotic vehicle 102 may navigate to an installation site for the solar module 202 as in FIG. 4A. The solar module 202 may be carried in the wagon 412 or on the robotic vehicle 102 as in the wagon-less aspect described above. Human operator(s) may be present alongside the robotic vehicle 102. The human operator(s) may manually place the solar module 202 over the bracket 406 such that the solar module 202 is aligned with the holes 408 of the bracket 406 (e.g., as in FIG. 4F). In some aspects, the robotic vehicle 102 may utilize the second arm 134 to fasten the solar module 202 to the bracket 406 (e.g., as in FIG. 4E and FIG. 4G). In some other aspects, the robotic vehicle 102 may place the second arm 134 into the Zero-G assist mode described above. The human operator(s) may then move the second arm 134 into a position near the bracket 406 such that the solar module 202 is aligned with the holes 408 of the bracket 406. The human operator(s) may cause the second arm 134 to fasten the solar module 202 to the bracket 406 (e.g., via a controller of the robotic vehicle 102). The robotic vehicle 102 may then navigate to an installation site for the next solar module (e.g., the next bracket on the torque bar 402). Such functionality may be useful in scenarios in which terrain of a solar park is not conducive to utilizing both the first arm 126 and the second arm 134. In some aspects in which the robotic vehicle 102 includes the second arm 134 and not the first arm 126, the robotic vehicle 102 may navigate to sites of already installed solar modules and perform a post-installation inspection of the already installed solar modules using the sensors 136 of the second arm 134.

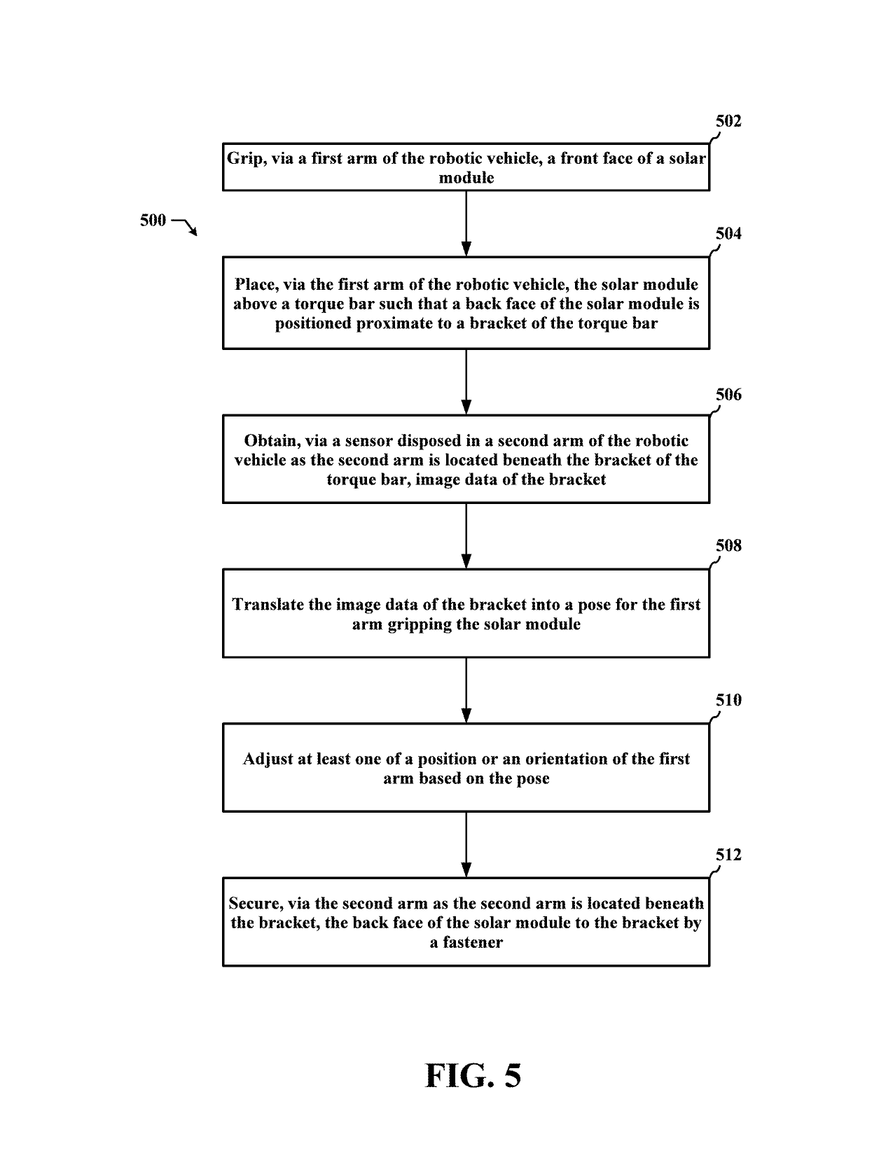

FIG. 5 is a flow diagram 500 of a method for solar module placement in accordance with some aspects of the present disclosure. The method may be performed by processing logic that may include hardware (e.g., a processing device), software (e.g., instructions running/executing on a processing device), firmware (e.g., microcode), or a combination thereof. In some aspects, at least a portion of the method may be performed by the robotic vehicle 102, the computing system 104, the processor 106, the computer system 600, the processing device 602, or a combination thereof.

The method illustrates example functions used by various embodiments. Although specific function blocks ("blocks") are disclosed in the method, such blocks are examples. That is, embodiments are well suited to performing various other blocks or variations of the blocks recited in the method. It is appreciated that the blocks in the method may be performed in an order different than presented, and that not all of the blocks in the method may be performed.

At block 502, a robotic vehicle grips, via a first arm of the robotic vehicle, a front face of a solar module. For example, the robotic vehicle may be the robotic vehicle 102, the first arm may be the first arm 126, the front face may be the front face 206, and the solar module may be the solar module 202. In another example, the solar module may be included in the solar modules 302 and/or the solar modules 414. In another example, block 502 may correspond to FIG. 4C.

At block 504, the robotic vehicle places, via the first arm of the robotic vehicle, the solar module above a torque bar such that a back face of the solar module is positioned proximate to a bracket of the torque bar. For example, the torque bar may be the torque bar 402, the back face may be the back face 208, and the bracket may be the bracket 406. In another example, block 504 may correspond to FIG. 4D.

At block 506, the robotic vehicle obtains, via a sensor disposed in a second arm of the robotic vehicle as the second arm is located beneath the bracket of the torque bar, image data of the bracket. For example, the sensor may be included in the sensors 136 and the second arm may be the second arm 134. For example, block 506 may correspond to FIG. 4E.

At block 508, the robotic vehicle translates the image data of the bracket into a pose for the first arm gripping the solar module. For example, block 508 may correspond to FIG. 4E.

At block 510, the robotic vehicle adjusts at least one of a position or an orientation of the first arm based on the pose. For example, block 510 may correspond to FIG. 4F.

At block 512, the robotic vehicle secures, via the second arm as the second arm is located beneath the bracket, the back face of the solar module to the bracket by a fastener. For example, block 510 may correspond to FIG. 4G.

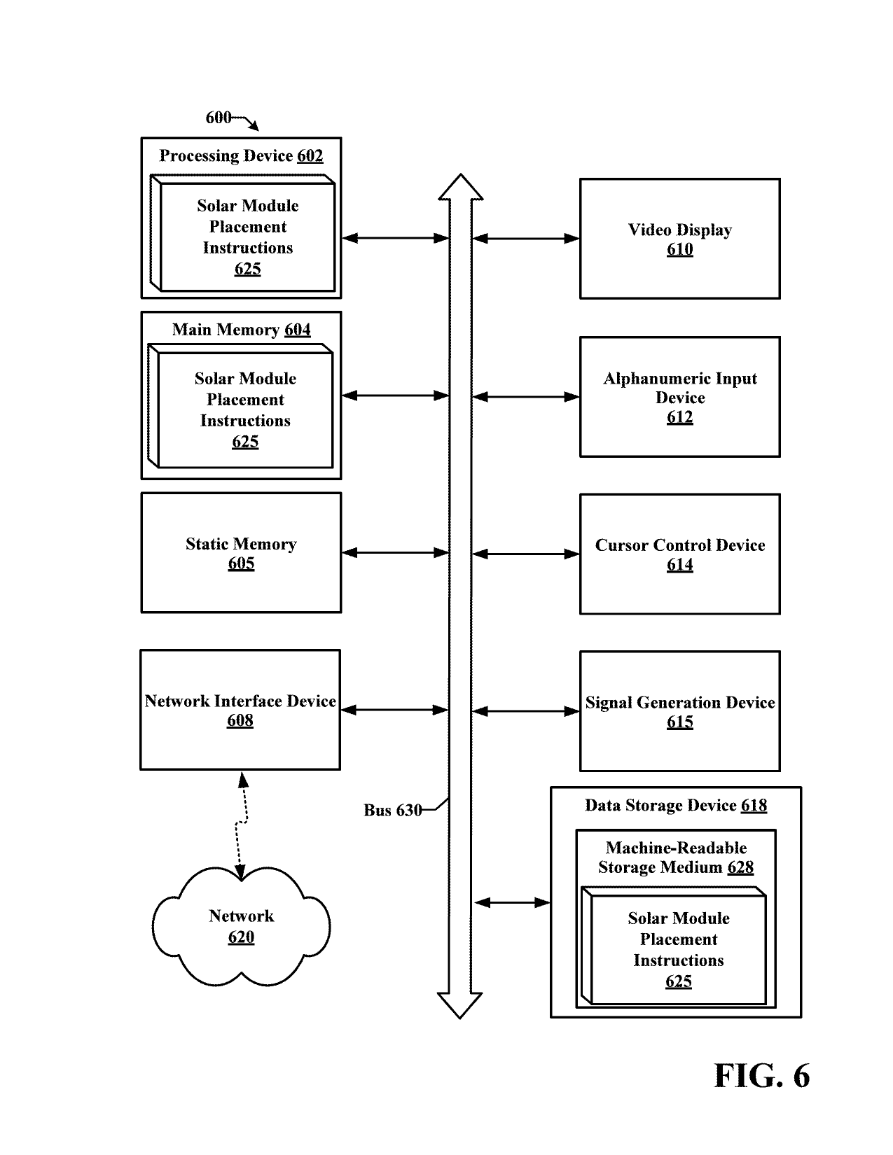

FIG. 6 illustrates a diagrammatic representation of a machine in the example form of a computer system 600 within which a set of instructions, for causing the machine to perform any one or more of the methodologies discussed herein for solar module placement.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, the computer system 600 may be representative of a server.

The computer system 600 includes a processing device 602, a main memory 604 (e.g., read-only memory (ROM), flash memory, dynamic random access memory (DRAM), a static memory 605 (e.g., flash memory, static random access memory (SRAM), etc.), and a data storage device 618 which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

The computer system 600 may further include a network interface device 608 which may communicate with a network 620. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 615 (e.g., an acoustic signal generation device, such as a speaker). In some embodiments, the video display unit 610, the alphanumeric input device 612, and the cursor control device 614 may be combined into a single component or device (e.g., an LCD touch screen).

The processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute solar module placement instructions 625, for performing the operations and steps discussed herein. For example, the solar module placement instructions 625 may include instructions for gripping, via a first arm of a robotic vehicle, a front face of a solar module; placing, via the first arm of the robotic vehicle, the solar module above a torque bar such that a back face of the solar module is positioned proximate to a bracket of the torque bar; obtaining, via a sensor disposed in a second arm of the robotic vehicle as the second arm is located beneath the bracket of the torque bar, image data of the bracket; translating the image data of the bracket into a pose for the first arm gripping the solar module; adjusting at least one of a position or an orientation of the first arm based on the pose; and securing, via the second arm as the second arm is located beneath the bracket, the back face of the solar module to the bracket by a fastener.

The data storage device 618 may include a machine-readable storage medium 628 that stores the solar module placement instructions 625 (e.g., software) embodying any one or more of the methodologies of functions described herein. The solar module placement instructions 625 may also reside, completely or at least partially, within the main memory 604 or within the processing device 602 during execution thereof by the computer system 600; the main memory 604 and the processing device 602 also constituting machine-readable storage media. The solar module placement instructions 625 may further be transmitted or received over a network 620 via the network interface device 608.

While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable storage medium includes any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The terms "first," "second," "third," "fourth," etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware--for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

The following examples are illustrative only and may be combined with other examples or teachings described herein, without limitation.

Example 1 is a method of installing solar modules performed by a robotic vehicle, the method comprising: gripping, via a first arm of the robotic vehicle, a front face of a solar module; placing, via the first arm of the robotic vehicle, the solar module above a torque bar such that a back face of the solar module is positioned proximate to a bracket of the torque bar; obtaining, via a sensor disposed in a second arm of the robotic vehicle as the second arm is located beneath the bracket of the torque bar, image data of the bracket; translating the image data of the bracket into a pose for the first arm gripping the solar module; adjusting at least one of a position or an orientation of the first arm based on the pose; and securing, via the second arm as the second arm is located beneath the bracket, the solar module to the bracket by a fastener.

Example 2 is the method of example 1, wherein the solar module rests on a surface on a side face of the solar module prior to the gripping, and wherein gripping the front face of the solar module comprises gripping the front face of the solar module as the solar module rests on the surface on the side face.

Example 3 is the method of any of examples 1-2, further comprising: navigating the robotic vehicle to a location of the torque bar based on at least one of a map of a solar site or a global navigation satellite system.

Example 4 is the method of example 3, wherein the first arm and the second arm are in a non-extended position on the robotic vehicle prior to the robotic vehicle arriving at the location of the torque bar, the method further comprising: extending the first arm and the second arm when the robotic vehicle arrives at the location.

Example 5 is the method of example 4, wherein a height of the robotic vehicle when the first arm and the second arm are in the non-extended position is less than five feet.

Example 6 is the method of any of examples 1-5, wherein translating the image data of the bracket into the pose for the first arm comprises: identifying a centroid of at least one hole in the bracket based on the image data, wherein the pose is based on the centroid.

Example 7 is the method of any of examples 1-6, wherein gripping the front face of the solar module comprises gripping the front face via a suction cup disposed in the first arm.

Example 8 is the method of any of examples 1-7, wherein the front face of the solar module comprises solar cells, and wherein the back face of the solar module comprises an opening for the bracket.

Example 9 is the method of any of examples 1-8, wherein the fastener comprises a huck bolt.

Example 10 is the method of any of examples 1-9, wherein the first arm comprises a first plurality of segments and the second arm comprises a second plurality of segments, wherein the first plurality of segments includes a gripping segment, and wherein the second plurality of segments includes the sensor and a fastening tool.

Example 11 is the method of any of examples 1-10, further comprising: releasing a grip of the first arm of the robotic vehicle from the front face of the solar module subsequent to securing the solar module to the bracket.

Example 12 is the method of any of examples 1-11, wherein the sensor comprises a depth camera, and wherein the image data comprises a point cloud.

Example 13 is the method of any of examples 1-12, further comprising: moving the second arm of the robotic vehicle to a first position beneath the bracket of the torque bar prior to obtaining the image data; and moving the second arm of the robotic vehicle to a second position beneath the bracket subsequent to adjusting at least one of the position or the orientation of the first arm, wherein securing the solar module to the bracket by the fastener occurs when the second arm is in the second position.

Example 14 is the method of any of examples 1-13, further comprising: capturing an image of the solar module subsequent to the solar module being secured to the bracket.

Example 15 is the method of any of examples 1-14, wherein: the first arm operates in an autonomous mode and the second arm operates in the autonomous mode; the first arm operates in the autonomous mode and the second arm operates in a zero gravity (Zero-G) assist mode, the first arm operates in the Zero-G assist mode and the second arm operates in the autonomous mode; or the first arm operates in the Zero-G assist mode and the second arm operates in the Zero-G assist mode.

Example 16 is the method of any of examples 1-15, wherein the solar module is carried on a wagon attached to the robotic vehicle prior to placing the solar module above the torque bar, or wherein the robotic vehicle comprises a gripping component that lifts a pallet including the solar module onto the robotic vehicle such that the solar module is carried on the robotic vehicle prior to placing the solar module above the torque bar

Example 17 is a robotic vehicle, comprising: a first arm; a second arm; a sensor disposed in the second arm; and a computing system, comprising: a processor; and memory storing instructions, that when executed by the processor, cause the robotic vehicle to implement a method as in any of examples 1-15.

Example 18 is the robotic vehicle of example 17, further comprising: a first actuator coupled to the first arm; and a second actuator coupled to the second arm, wherein to adjust the at least one of the position or the orientation of the first arm, the instructions, when executed by the processor, cause the robotic vehicle to transmit signals to the first actuator to control the at least one of the position or the orientation of the first arm.

Example 19 is the robotic vehicle of any of examples 17-18, further comprising: a propulsion system.

Example 20 is a computing system, comprising: a processor; and memory storing instructions that, when executed by the processor, cause the processor to cause a robotic vehicle to implement a method as in any of examples 1-16.

Example 21 is a non-transitory computer readable storage medium comprising instructions that, when executed by the processor, cause the processor to cause a robotic vehicle to implement a method as in any of examples 1-16.

Example 22 is a robotic vehicle comprising means for perform a method as in any of examples 1-16.

Example 23 is a computer program product for implementing a method as in any of examples 1-16.

What is claimed is:

1. A method of installing solar modules performed by a robotic vehicle, the method comprising:
gripping, via a first arm of the robotic vehicle, a front face of a solar module;
placing, via the first arm of the robotic vehicle, the solar module above a torque bar such that a back face of the solar module is positioned proximate to a bracket of the torque bar;
obtaining, via a sensor disposed in a second arm of the robotic vehicle as the second arm is located beneath the bracket of the torque bar, image data of the bracket;
translating the image data of the bracket into a pose for the first arm gripping the solar module;
adjusting at least one of a position or an orientation of the first arm based on the pose; and
securing, via the second arm as the second arm is located beneath the bracket, the solar module to the bracket by a fastener.

2. The method of claim 1, wherein the solar module rests on a surface on a side face of the solar module prior to the gripping, and wherein gripping the front face of the solar module comprises gripping the front face of the solar module as the solar module rests on the surface on the side face.

3. The method of claim 1, further comprising:
navigating the robotic vehicle to a location of the torque bar based on at least one of a map of a solar site or a global navigation satellite system.

4. The method of claim 3, wherein the first arm and the second arm are in a non-extended position on the robotic vehicle prior to the robotic vehicle arriving at the location of the torque bar, the method further comprising:
extending the first arm and the second arm when the robotic vehicle arrives at the location.

5. The method of claim 4, wherein a height of the robotic vehicle when the first arm and the second arm are in the non-extended position is less than five feet.

6. The method of claim 1, wherein translating the image data of the bracket into the pose for the first arm comprises:
identifying a centroid of at least one hole in the bracket based on the image data, wherein the pose is based on the centroid.

7. The method of claim 1, wherein gripping the front face of the solar module comprises gripping the front face via a suction cup disposed in the first arm.

8. The method of claim 1, wherein the front face of the solar module comprises solar cells, and wherein the back face of the solar module comprises an opening for the bracket.

9. The method of claim 1, wherein the solar module is carried on a wagon attached to the robotic vehicle prior to placing the solar module above the torque bar, or wherein the robotic vehicle comprises a gripping component that lifts a pallet including the solar module onto the robotic vehicle such that the solar module is carried on the robotic vehicle prior to placing the solar module above the torque bar.

10. The method of claim 1, wherein the first arm comprises a first plurality of segments and the second arm comprises a second plurality of segments, wherein the first plurality of segments includes a gripping segment, and wherein the second plurality of segments includes the sensor and a fastening tool.

11. The method of claim 1, further comprising:
releasing a grip of the first arm of the robotic vehicle from the front face of the solar module subsequent to securing the solar module to the bracket.

12. The method of claim 1, wherein the sensor comprises a depth camera, and wherein the image data comprises a point cloud.

13. The method of claim 1, further comprising:
moving the second arm of the robotic vehicle to a first position beneath the bracket of the torque bar prior to obtaining the image data; and
moving the second arm of the robotic vehicle to a second position beneath the bracket subsequent to adjusting at least one of the position or the orientation of the first arm, wherein securing the solar module to the bracket by the fastener occurs when the second arm is in the second position.

14. The method of claim 1, further comprising:
capturing an image of the solar module subsequent to the solar module being secured to the bracket.

15. The method of claim 1, wherein:
the first arm operates in an autonomous mode and the second arm operates in the autonomous mode;
the first arm operates in the autonomous mode and the second arm operates in a zero gravity (Zero-G) assist mode;
the first arm operates in the Zero-G assist mode and the second arm operates in the autonomous mode; or
the first arm operates in the Zero-G assist mode and the second arm operates in the Zero-G assist mode.

16. A robotic vehicle, comprising:
a first arm;
a second arm;
a sensor disposed in the second arm; and
a computing system, comprising:
a processor; and
memory storing instructions, that when executed by the processor, cause the robotic vehicle to:
grip, via the first arm, a front face of a solar module;
place, via the first arm of the robotic vehicle, the solar module above a torque bar such that a back face of the solar module is positioned proximate to a bracket of the torque bar;
obtain, via the sensor as the second arm is located beneath the bracket of the torque bar, image data of the bracket;
translate the image data of the bracket into a pose for the first arm gripping the solar module;
adjust at least one of a position or an orientation of the first arm based on the pose; and
secure, via the second arm as the second arm is located beneath the bracket, the solar module to the bracket by a fastener.

17. The robotic vehicle of claim 16, further comprising:
a first actuator coupled to the first arm, wherein to adjust the at least one of the position or the orientation of the first arm, the instructions, when executed by the processor, cause the robotic vehicle to transmit signals to the first actuator to control the at least one of the position or the orientation of the first arm.

18. The robotic vehicle of claim 16, further comprising:
a propulsion system.

19. The robotic vehicle of claim 16, wherein the instructions, when executed by the processor, further cause the robotic vehicle to:
release a grip of the first arm of the robotic vehicle from the front face of the solar module subsequent to securing the solar module to the bracket.

20. A computing system, comprising,
a processor; and
memory storing instructions that, when executed by the processor, cause the processor to cause a robotic vehicle to:
grip, via a first arm of the robotic vehicle, a front face of a solar module;
place, via the first arm of the robotic vehicle, the solar module above a torque bar such that a back face of the solar module is positioned proximate to a bracket of the torque bar;
obtain, via a sensor disposed in a second arm of the robotic vehicle as the second arm is located beneath the bracket of the torque bar, image data of the bracket;
translate the image data of the bracket into a pose for the first arm gripping the solar module;
adjust at least one of a position or an orientation of the first arm based on the pose; and
secure, via the second arm as the second arm is located beneath the bracket, the solar module to the bracket by a fastener.
